(19) United States
(12) Patent Application Publication
(10) Pub. No.: US 2024/0202561 A1
(43) Pub. Date: Jun. 20, 2024

(54) METHOD AND SYSTEM FOR DOWNFOLDING ELECTRONIC HAMILTONIANS USING A HYBRID QUANTUM-CLASSICAL ARCHITECTURE

(71) Applicant: Tata Consultancy Services Limited, Mumbai (IN)

(72) Inventors: ANIRBAN MUKHERJEE, Mumbai (IN); ANEKAIT HITESH KARIYA, Thane (West) (IN)

(73) Assignee: Tata Consultancy Services Limited, Mumbai (IN)

(21) Appl. No.: 18/531,558

(22) Filed: Dec. 6, 2023

(30) Foreign Application Priority Data
Dec. 8, 2022 (IN) 202221070912

(51) Int. Cl. G06N 10/20; G06N 10/60

(52) U.S. Cl. CPC G06N 10/20; G06N 10/60

(57) ABSTRACT

Conventional Hamiltonian downfolding methods involve approximating exponential within the double unitary coupled cluster transformation which effects accuracy of the resultant Hamiltonian. Thus, the present disclosure provides a method for downfolding electronic Hamiltonians using a hybrid quantum-classical architecture wherein similarity transformation in such a way that the exponential terminates at linear order. In addition, a many body Bloch equation is defined which embodies every similarity downfolding transformation step. From the Bloch equation, a system of polynomial equations is derived for downfolding one molecular orbital. Quantum Circuits are used to facilitate solving the polynomial equations, which helps in constructing a lower dimensional Hamiltonian with one less molecular orbital at every downfolding step/iteration. The entire process gets repeated for every orbital downfolding, leading to a smaller dimensional effective Hamiltonian.

### PRIORITY CLAIM

This U.S. patent application claims priority under 35 U.S.C. § 119 to: Indian Patent Application No. 202221070912, filed on Dec. 8, 2022. The entire contents of the aforementioned application are incorporated herein by reference.

### TECHNICAL FIELD

The disclosure herein generally relates to quantum computing, and, more particularly, to a method and system for downfolding electronic Hamiltonians using a hybrid quantum-classical architecture.

### BACKGROUND

As quantum hardware and algorithms continue to develop, various industry sectors, particularly the pharmaceutical and material design domains, are applying quantum computation paradigm to their specific problems. In most problems of practical interest such as drug-screening, identifying suitable cathode materials in rechargeable batteries, discovering materials for carbon capture etc., the computational bottleneck is finding the electronic Potential Energy Surface (PES) as a function of the nuclei coordinates. A chemically accurate PES needs to be calculated for a small system of molecules which can then be used to construct ab-initio force fields and generalized potentials that can directly impact Molecular dynamics or Monte-Carlo simulations.

To formulate the PES, Born-Oppenheimer approximation is used to construct an electronic Hamiltonian as a function of the nuclear coordinates. For example a single drug molecule of aspirin (C₉H₈O₄) in gas phase represented in the STO-6G basis comprises 21 nuclear coordinates and 73 spatial orbitals, and the electronic Hamiltonian is very dense with 25×10⁶ terms. Therefore diagonalizing such a large Hamiltonian and getting even the low energy eigenstates is a hard challenge. Both the one-electron and two-electron potentials namely hᵢⱼ and hᵢⱼₖₗ will be a function of the 21 nuclear coordinates. Furthermore, from a practical application angle, two or more such molecules need to be studied in solvent medium to simulate the dispersion energy contribution. Aspirin is the smallest drug molecule which has 73 spatial orbitals. So, for two Aspirin molecules in a solvent medium there are more than 200 atomic orbitals Thus, the associated electronic Hamiltonian H is a massive object with 2^{2N}×2^{2N} matrix for N atomic orbitals(the 2 factor in the power arises by accounting for spin). Because of this complexity, a means to do successive problem reduction is needed. The eigenvalues and eigenvectors of H describe a many electron system's static and dynamic properties. However, the computational complexity for eigenvalue decomposition of H scales exponentially with N. An alternate way to solve the problem would be to construct effective Hamiltonians from H that acts on a reduced space of orbitals.

Effective Hamiltonian is a lower-dimensional representation of the parent electronic Hamiltonian H. It describes physics of a reduced subspace with fewer active orbitals than the full Hamiltonian. Constructing an effective Hamiltonian is a central goal in physics, with applications in the study of quantum phase transitions, quantum chemistry simulations, novel material prediction and many more. The concept of effective Hamiltonian emerges in a diverse set of many-body methods: many-body perturbation theory, Schieffer-Wolff transformation, similarity transformation, continuous unitary transformations, Hamiltonian truncation, Feshbach-Lowdin-Fano method, multireference perturbation theory, Hamiltonian Monte Carlo, Numerical renormalization group, Hamiltonian downfolding and so on. Another approach for estimating energy is the quantum phase estimation algorithm based on Qubitization. The time evolution operator used in phase estimation e^{iHT} is reconstructed using quantum signal processing starting from the Quantum walk operator

$${e}^{i arrcos ( \frac{H}{{‖ H ‖}_{1}} )} ,$$

where ∥H∥₁ is the 1-norm of the Hamiltonian. In one of the work (Joonho Lee et. al. Even more efficient quantum computations of chemistry through tensor hypercontraction. PRX Quantum, 2(3):030305, 2021), authors present an efficient way of representing the Hamiltonian in a quantum circuit using double factorization and tensor hypercontraction. It substantially reduces quantum resource usage compared to single factorization and quantum phase estimation. However, the number of physical qubits and Toffoli gates required is still extremely high.

Once the effective Hamiltonian is obtained, it has to be solved in order to obtain the PES. This can be done either by a similarity transformation or a unitary transformation wherein time evolution of the reduced Hamiltonian is tracked via a time evolution operator (e^{iHT}). The exponential scaling of the Hamiltonian size with respect to the number of orbitals makes Hamiltonian simulation an arduous task. An initial treatment of the parent problem via a reduction approach can render an effective Hamiltonian with fewer orbitals, which may help in handling the time evolution more effectively. A relatively new approach to Hamiltonian simulation is the qubitization algorithm, where the electronic Hamiltonian is block-encoded in a higher dimensional unitary operator, thereby realizing an oracular representation. The time evolution e^{i arccos (H/λ)} (where λ is the 1-norm of H) is implemented using oracles comprising a qubitization circuit. Using quantum signal processing, this signal can be transformed into a truncated Taylor series expansion for e^{iHT}, where T=tλ denotes the effective evolution time. In state of the art methods, the effective Hamiltonian is simulated by performing a double unitary transformation or a coupled cluster transformation wherein the exponential transformations are expanded and then truncated up to a certain point. This effects the accuracy of the calculation and also makes it harder to simulate on quantum circuits.

### SUMMARY

Embodiments of the present disclosure present technological improvements as solutions to one or more of the above-mentioned technical problems recognized by the inventors in conventional systems. For example, in one embodiment, a method for downfolding electronic Hamiltonians using a hybrid quantum-classical architecture is provided. The method includes receiving, by one or more classical hardware processors, a plurality of molecular orbitals associated with a plurality of molecules and a plurality of similarity transformation parameters. Further, the method includes determining, by the one or more classical hardware processors, one-electron and two-electron integrals based on each of the plurality of molecular orbitals. Furthermore the method includes iteratively performing, by the one or more classical hardware processors and the plurality of unentangled QPUs, a plurality of steps until number of the plurality of molecular orbitals is zero. Number of the plurality of molecular orbitals is reduced by one at each iteration. The plurality of steps comprising: (i) determining a plurality of projection operators for last molecular orbital that has to be decoupled among the plurality of molecular orbitals; (ii) constructing a qubit Hamiltonian based on the one-electron and two-electron integrals; (iii) determining a residual vector by transforming the qubit Hamiltonian to a polynomial equation system using the plurality of projection operators; and (iv) solving the polynomial equation system to update the one-electron and two-electron integrals by iteratively performing Levenberg-Marquadt Method (LMM) until norm of a product of a Jacobian matrix and the residual vector is less than a pre-defined tolerance value. The Jacobian matrix is obtained from the residual vector based on the plurality of similarity transformation parameters.

In another aspect, a system for downfolding electronic Hamiltonians using a hybrid quantum-classical architecture is provided. The system includes one or more classical hardware processors communicably coupled to a plurality of unentangled Quantum Processor Units (QPUs) via interfaces, wherein the one or more classical hardware processors comprises at least one memory storing programmed instructions; one or more Input/Output (I/O) interfaces; and one or more hardware processors operatively coupled to the at least one memory, wherein the one or more classical hardware processors and the plurality of unentangled QPUs are configured by the programmed instructions to receive a plurality of molecular orbitals associated with a plurality of molecules and a plurality of similarity transformation parameters. Further, the one or more classical hardware processors are configured to determine one-electron and two-electron integrals based on each of the plurality of molecular orbitals. Furthermore the one or more classical hardware processors and the plurality of unentangled QPUs are configured by the programmed instructions to iteratively perform a plurality of steps until number of the plurality of molecular orbitals is zero. Number of the plurality of molecular orbitals is reduced by one at each iteration. The plurality of steps comprising: (i) determining, by the one or more classical hardware processors, a plurality of projection operators for last molecular orbital that has to be decoupled among the plurality of molecular orbitals; (ii) constructing, by the one or more classical hardware processors, a qubit Hamiltonian based on the one-electron and two-electron integrals; (iii) determining, by the one or more classical hardware processors, a residual vector by transforming the qubit Hamiltonian to a polynomial equation system using the plurality of projection operators; and (iv) solving, by the one or more classical hardware processors and the plurality of unentangled QPUs, the polynomial equation system to update the one-electron and two-electron integrals by iteratively performing Levenberg-Marquadt Method (LMM) until norm of a product of a Jacobian matrix and the residual vector is less than a pre-defined tolerance value. The Jacobian matrix is obtained from the residual vector based on the plurality of similarity transformation parameters.

In yet another aspect, a computer program product including a non-transitory computer-readable medium having embodied therein a computer program for downfolding electronic Hamiltonians using a hybrid quantum-classical architecture is provided. The computer readable program, when executed on a system comprising one or more classical hardware processors communicably coupled to a plurality of unentangled Quantum Processor Units (QPUs) via interfaces, causes the computing device to receive a plurality of molecular orbitals associated with a plurality of molecules and a plurality of similarity transformation parameters. Further, the computer readable program, when executed on the system comprising one or more classical hardware processors communicably coupled to a plurality of unentangled QPUs via interfaces, causes the computing device to determine one-electron and two-electron integrals based on each of the plurality of molecular orbitals. Furthermore, the computer readable program, when executed on the system comprising one or more classical hardware processors communicably coupled to a plurality of unentangled QPUs via interfaces, causes the computing device to iteratively perform a plurality of steps until number of the plurality of molecular orbitals is zero. Number of the plurality of molecular orbitals is reduced by one at each iteration. The plurality of steps comprising: (i) determining, by the one or more classical hardware processors, a plurality of projection operators for last molecular orbital that has to be decoupled among the plurality of molecular orbitals; (ii) constructing, by the one or more classical hardware processors, a qubit Hamiltonian based on the one-electron and two-electron integrals; (iii) determining, by the one or more classical hardware processors, a residual vector by transforming the qubit Hamiltonian to a polynomial equation system using the plurality of projection operators; and (iv) solving, by the one or more classical hardware processors and the plurality of unentangled QPUs, the polynomial equation system to update the one-electron and two-electron integrals by iteratively performing Levenberg-Marquadt Method (LMM) until norm of a product of a Jacobian matrix and the residual vector is less than a pre-defined tolerance value. The Jacobian matrix is obtained from the residual vector based on the plurality of similarity transformation parameters.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for downfolding electronic Hamiltonians, in accordance with some embodiments of the present disclosure.

FIGS. 2A and 2B, collectively referred as FIG. 2 is an exemplary flow diagram illustrating a method for downfolding electronic Hamiltonians, implemented by the system of FIG. 1, in accordance with some embodiments of the present disclosure.

FIG. 3 illustrates an alternative representation of the flow diagram of FIG. 2, in accordance with some embodiments of the present disclosure.

FIG. 4 illustrates number of qubits required for downfolding of Hydrogen atoms using method of FIG. 2, in accordance with some embodiments of the present disclosure.

FIG. 5 illustrates number of Toffoli's required for downfolding of Hydrogen atoms using method of FIG. 2, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments

The present disclosure provides a method for downfolding electronic Hamiltonians using a hybrid quantum-classical architecture. Conventional methods construct effective Hamiltonian by expanding the exponential within the double unitary coupled cluster transformation into a Taylor series which is then truncated up to the double commutator. This effects accuracy of the resultant Hamiltonian. On the other hand if the double unitary coupled cluster transformation is implemented in a quantum circuit framework then the unitary operator needs to be written in a Trotter product representation. However, Trotter product circuits are very dense. The present disclosure provides an alternative similarity transformation where the exponentiation automatically terminates at linear order. Using ancilla qubits along with system qubits it can be represented via shallow depth circuits and can be exactly implemented. The similarity transformation is generated by exponentiating a weighted sum of product of electron creation and annihilation operators called a generator. A specific form of the generator is determined in the present disclosure that allows the exponential similarity transformation to automatically terminate at linear order. This can be directly implemented in a quantum circuit architecture and enables construction of effective Hamiltonian more accurately and in a less complex way.

In addition, a many body Bloch equation is defined which embodies every similarity downfolding transformation step. From the Bloch equation, a system of polynomial equations is derived for downfolding one molecular orbital. Quantum Circuits are used to facilitate solving the polynomial equations, which helps in constructing a lower dimensional Hamiltonian with one less molecular orbital at every downfolding step/iteration. The entire process gets repeated for every orbital downfolding, leading to a smaller dimensional effective Hamiltonian.

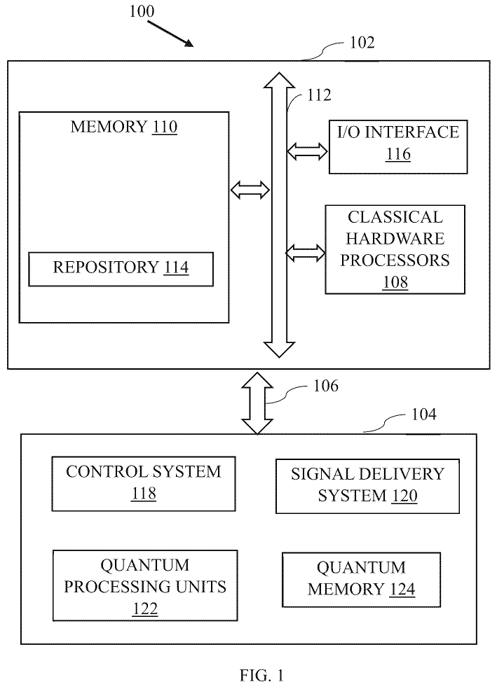

Referring now to the drawings, and more particularly to FIGS. 1 through 5. where similar reference characters denote corresponding features consistently throughout the figures, there are shown preferred embodiments and these embodiments are described in the context of the following exemplary system and/or method.

FIG. 1 is a functional block diagram of a system for downfolding electronic Hamiltonians, in accordance with some embodiments of the present disclosure. The system 100 includes a classical computing system 102, a quantum computing system 104 and a communication interface 106.

The classical computing system 102 comprises classical hardware processors 108, at least one memory such as a memory 110, an I/O interface 116. The classical hardware processors 108, the memory 110, and the Input/Output (I/O) interface 116 may be coupled by a system bus such as a system bus 112 or a similar mechanism. In an embodiment, the classical hardware processors 108 can be one or more hardware processors. The classical hardware processors and the hardware processors is interchangeably used throughout the document. Similarly, the classical computing system is a normal computing system.

The I/O interface 116 may include a variety of software and hardware interfaces, for example, a web interface, a graphical user interface, and the like, for example, interfaces for peripheral device(s), such as a keyboard, a mouse, an external memory, a printer and the like. Further, the I/O interface 116 may enable the system 100 to communicate with other devices, such as web servers, and external databases. The I/O interface 116 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 116 may include one or more ports for connecting several computing systems with one another or to another server computer.

The one or more hardware processors 108 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 108 is configured to fetch and execute computer-readable instructions stored in the memory 110.

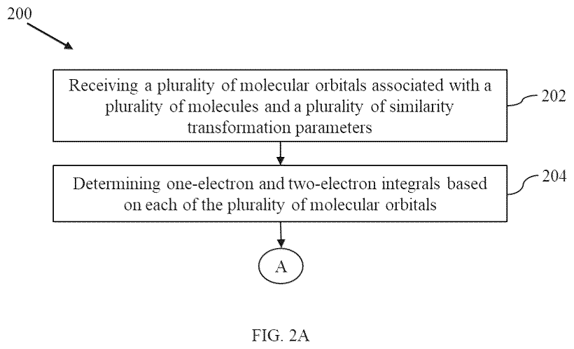

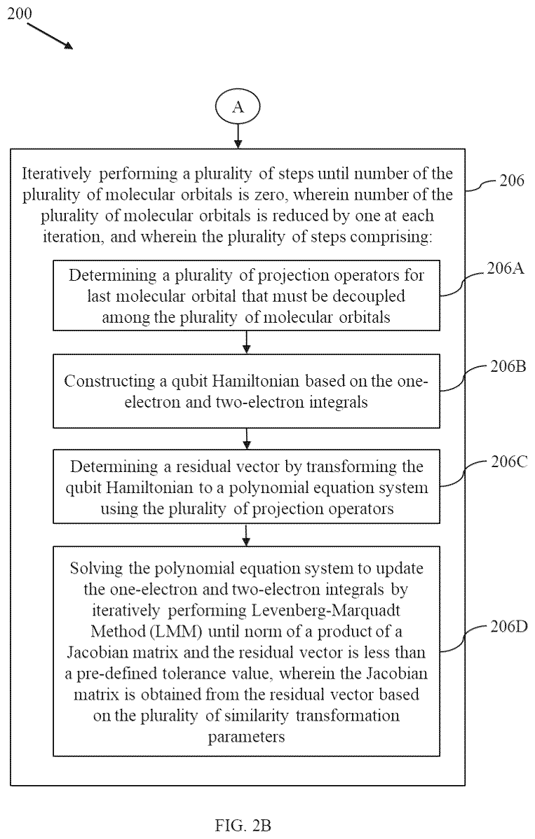

The memory 110 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 110 includes a data repository 114. The data repository (or repository) 114 may include a plurality of abstracted piece of code for refinement and data that is processed, received, or generated as a result of the execution of the method illustrated in FIGS. 2 and 3. Although the data repository 114 is shown internal to the system 100, it should be noted that, in alternate embodiments, the data repository 114 can also be implemented external to the system 100, where the data repository 114 may be stored within a database (repository 114) communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS).

The example quantum computing system 104 shown in FIG. 1 includes a control system 118, a signal delivery system 120, a plurality of Quantum Processing Units (QPUs) 122 and a quantum memory 124. The plurality of QPUs is unentangled and hence alternatively called as the plurality of unentangled QPUs. The quantum computing system 104 may include additional or different features, and the components of a quantum computing system may operate as described with respect to FIG. 1 or in another manner.

The example quantum computing system 104 shown in FIG. 1 can perform quantum computational tasks (such as, for example, quantum simulations or other quantum computational tasks) by executing quantum algorithms. In some implementations, the quantum computing system 104 can perform quantum computation by storing and manipulating information within individual quantum states of a composite quantum system. For example, Qubits (i.e., Quantum bits) can be stored in and represented by an effective two-level sub-manifold of a quantum coherent physical system in the plurality of QPUs 122. In an embodiment, the quantum computing system 104 can operate using gate-based models for quantum computing. For example, the Qubits can be initialized in an initial state, and a quantum logic circuit comprised of a series of quantum logic gates can be applied to transform the qubits and extract measurements representing the output of the quantum computation. The example QPUs 122 shown in FIG. 1 may be implemented, for example, as a superconducting quantum integrated circuit that includes Qubit devices. The Qubit devices may be used to store and process quantum information, for example, by operating as ancilla Qubits, data Qubits or other types of Qubits in a quantum algorithm. Coupler devices in the superconducting quantum integrated circuit may be used to perform quantum logic operations on single qubits or conditional quantum logic operations on multiple qubits. In some instances, the conditional quantum logic can be performed in a manner that allows large-scale entanglement within the QPUs 122. Control signals may be delivered to the superconducting quantum integrated circuit, for example, to manipulate the quantum states of individual Qubits and the joint states of multiple Qubits. In some instances, information can be read from the superconducting quantum integrated circuit by measuring the quantum states of the qubit devices. The QPUs 122 may be implemented using another type of physical system.

The example QPUs 122, and in some cases all or part of the signal delivery system 120, can be maintained in a controlled cryogenic environment. The environment can be provided, for example, by shielding equipment, cryogenic equipment, and other types of environmental control systems. In some examples, the components in the QPUs 122 operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In the example shown in FIG. 1, the signal delivery system 120 provides communication between the control system 118 and the QPUs 122. For example, the signal delivery system 120 can receive control signals from the control system 118 and deliver the control signals to the QPUs 122. In some instances, the signal delivery system 120 performs preprocessing, signal conditioning, or other operations to the control signals before delivering them to the QPUs 122. In an embodiment, the signal delivery system 120 includes connectors or other hardware elements that transfer signals between the QPUs 122 and the control system 118. For example, the connection hardware can include signal lines, signal processing hardware, filters, feedthrough devices (e.g., light-tight feedthroughs, etc.), and other types of components. In some implementations, the connection hardware can span multiple different temperature and noise regimes. For example, the connection hardware can include a series of temperature stages that decrease between a higher temperature regime (e.g., at the control system 118) and a lower temperature regime (e.g., at the QPUs 122).

In the example quantum computer system 104 shown in FIG. 1, the control system 118 controls operation of the QPUs 122. The example control system 118 may include data processors, signal generators, interface components and other types of systems or subsystems. Components of the example control system 118 may operate in a room temperature regime, an intermediate temperature regime, or both. For example, the control system 118 can be configured to operate at much higher temperatures and be subject to much higher levels of noise than are present in the environment of the QPUs 122. In some embodiments, the control system 118 includes a classical computing system that executes software to compile instructions for the QPUs 122. For example, the control system 118 may decompose a quantum logic circuit or quantum computing program into discrete control operations or sets of control operations that can be executed by the hardware in the QPUs 122. In some examples, the control system 118 applies a quantum logic circuit by generating signals that cause the Qubit devices and other devices in the QPUs 122 to execute operations. For instance, the operations may correspond to single-Qubit gates, two-Qubit gates, Qubit measurements, etc. The control system 118 can generate control signals that are communicated to the QPUs 122 by the signal delivery system 120, and the devices in the QPUs 122 can execute the operations in response to the control signals.

In some other embodiments, the control system 118 includes one or more classical computers or classical computing components that produce a control sequence, for instance, based on a quantum computer program to be executed. For example, a classical processor may convert a quantum computer program to an instruction set for the native gate set or architecture of the QPUs 122. In some cases, the control system 118 includes a microwave signal source (e.g., an arbitrary waveform generator), a bias signal source (e.g., a direct current source) and other components that generate control signals to be delivered to the QPUs 122. The control signals may be generated based on a control sequence provided, for instance, by a classical processor in the control system 118. The example control system 118 may include conversion hardware that digitizes response signals received from the QPUs 122. The digitized response signals may be provided, for example, to a classical processor in the control system 118.

In some embodiments, the quantum computer system 104 includes multiple quantum information processors that operate as respective quantum processor units (QPU). In some cases, each QPU can operate independent of the others. For instance, the quantum computer system 104 may be configured to operate according to a distributed quantum computation model, or the quantum computer system 104 may utilize multiple QPUs in another manner. In some implementations, the quantum computer system 104 includes multiple control systems, and each QPU may be controlled by a dedicated control system. In some implementations, a single control system can control multiple QPUs; for instance, the control system 118 may include multiple domains that each control a respective QPU. In some instances, the quantum computing system 104 uses multiple QPUs to execute multiple unentangled quantum computations (e.g., multiple Variational Quantum Eigen solver (VQE)) that collectively simulate a single quantum mechanical system.

In an embodiment, the quantum memory 124 is a quantum-mechanical version of classical computer memory. The classical computer memory stores information such as binary states and the quantum memory 124 stores a quantum state for later retrieval. These states hold useful computational information known as Qubits. In an embodiment, the communication interface 106 which connects the classical computing system 102 and the quantum computing system 104 is a high speed digital interface.

FIG. 2 is an exemplary flow diagram illustrating a method 200 for downfolding electronic Hamiltonians implemented by the system of FIG. 1, according to some embodiments of the present disclosure. In an embodiment, the system 100 includes one or more data storage devices or the memory 110 operatively coupled to the one or more hardware processor(s) 108 and is configured to store instructions for execution of steps of the method 200 by the one or more hardware processors 108. The steps of the method 200 of the present disclosure will now be explained with reference to the components or blocks of the system 100 as depicted in FIG. 1 and the steps of flow diagram as depicted in FIGS. 2 and 3. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communication network. The order in which the method 200 is described is not intended to be construed as a limitation, and any number of the described method blocks can be combined in any order to implement the method 200, or an alternative method. Furthermore, the method 200 can be implemented in any suitable hardware, software, firmware, or combination thereof.

Now referring to FIG. 2, at step 202 of the method 200, one or more classical hardware processors are configured to receive a plurality of molecular orbitals (MOs) associated with a plurality of molecules and a plurality of similarity transformation parameters as input. For example, to simulate a system of two Aspirin molecules in solvent medium around 200 spatial molecular orbitals are required. For simulating this system with downfolding 30 qubits and 2000 initial parameter values are needed for the associated similarity transformation. In an embodiment, the plurality of molecular orbitals are defined based on Hartree-Fock (HF) theory. As understood by a person skilled in the art, the HF MOs are grouped into virtual orbitals V, core orbitals [symbol] , and active space orbitals [symbol] . The absolute energy difference of the HF MOs (labeled u) from the HOMO (Highest Occupied Molecular Orbital) energy E_{HOMO} is ϵₖ=|Eᵢ−E_{HOMO}|. The MO labels 1, 2, . . . , N are ordered with reference to the absolute energy differences as ϵ₁≤ϵ₂≤ . . . ≤ϵ_{N}. If k∈V then within Hartree-Fock theory if the MO is unoccupied then n_{k↑}+n_{k↓}=0. If k∈ [symbol] then n_{k↑}+n_{k↓}=2 and if k∈ [symbol] then n_{k↑}+n_{k↓}=0,1,2.

Further, at step 204 of the method 200, one or more classical hardware processors are configured to determine one-electron and two-electron integrals of the plurality of molecules based on their molecular orbitals. The one-electron and two-electron integrals are determined using tools such as Python-based Simulations of Chemistry Framework (PySCF), NorthWest computational Chemistry (NWchem) etc.

Further, at step 206 of the method 200, the one or more classical hardware processors and the plurality of unentangled QPUs are configured to iteratively perform a plurality of steps until number of the plurality of molecular orbitals is zero. The number or count of the plurality of molecular orbitals is reduced by one at each iteration. The plurality of steps comprise steps 206A to 206D as described herein.

At step 206A, a plurality of projection operators are determined for last molecular orbital that has to be decoupled among the plurality of molecular orbitals. The last molecular orbital has up spin (μσ). The projection operators P= [symbol] and its complement Q=1− [symbol] are defined in terms of up spin according to equations 1 and 2 respectively, wherein \hat{n}_{μσ}=f_{μσ}^{†}f_{μσ}. The projection operators P and Q together form a Hilbert space, i.e. P_{(N)}+Q_{(N)}=I^{⊗2N}. In the equations 1 and 2, N represents the n^{th} molecular orbital and this value is reduced by 1 at each iteration. As illustrated in FIGS. 3, N=N−1 in the next iteration.

P_{(N)}=(1−\hat{n}_{N↑})(1−\hat{n}_{N↓}) (1)

Q_{(N)}=\hat{n}_{N↑}+\hat{n}_{N↓}+\hat{n}_{N↑}\hat{n}_{N↓} (2)

At step 206B, a qubit Hamiltonian is constructed based on the one-electron and two-electron integrals of the molecule. The qubit Hamiltonian is given in equation 3. Now referring to equation 3, hᵢⱼ^{1,σ,(N)} and hᵢⱼₖₗ^{1,σ,σ′,(N)} are the one-electron and two-electron integrals, respectively, f_{iσ}^{†} and f_{jσ} are electronic creation and annihilation operators where i is a collective index (tuples) comprising (oᵢ, σᵢ), o is orbital index belonging to (s,p,d,f) orbitals, and σ represents α/β or ↑/↓ spin index or spin orbitals. The index (N) denotes N correlated MOs which is reduced by 1 at each iteration.

H_{(N)}=E_{i,j,σ}hᵢⱼ^{1,σ,(N)}f_{iσ}^{†}f_{iσ}+Σ_{ijkl,σσ′}hᵢⱼₖₗ^{2,σσ′,(N)}f_{iσ}^{†}f_{jσ}^{†},f_{kσ′}f_{lσ} (3)

Once the qubit Hamiltonian is obtained, at step 206C, a residual vector is determined by transforming the qubit Hamiltonian to a polynomial equation system using the plurality of projection operators. The similarity transformation of the qubit Hamiltonian S_{(N)} is generated by the exponential of η_{(N)} such that Bloch equation (equation 4) is satisfied. Unlike state of the art methods which approximate the exponential by truncating Taylor series, the present disclosure provides defines exact value of e^{ημ} which greatly reduces the complexity and improves the accuracy. If the generator η_{(N)} satisfies the linearization condition Q_{(N)}η_{(N)}P_{(N)}=η_{(N)} then a linear representation of the similarity transform S_{(N)}=1+η_{(N)} can be obtained. Thus, η_{(N)} is chosen such that its exponential is equal to 1+η_{(N)} which can be calculated without any approximation. The generator η_{(N)} is defined according to equation 5.

Q_{(N)}S_{(N)}⁻¹H_{(N)}S_{(N)}P_{(N)}=0 (4)

η_{(N)}=Σ_{iσ}tᵢ^{1,σ,(N)}(1−\hat{n}_{i-σ})f_{Nσ}^{†}f_{iσ}+Σᵢⱼtᵢⱼ^{2,(N)}f_{N↑}^{†}f_{N↓}^{†}f_{i↓}f_{i↑} (5)

The generator defined by equation 5 comprises 2N singles excitation amplitudes tᵢ^{1,σ,(N)} and Ne doubles excitation amplitudes tᵢⱼ^{2,(N)}. It satisfies linearization condition, size consistency and extensively condition. The generator is then substituted into the Bloch equation in equation 4 and then the fermionic operators comprised in the Bloch equation are normal ordered. For the Bloch equation to be satisfied, the coefficients of the independent normal ordered fermionic terms must be eliminated: singles excitation-(iσ→Nσ), doubles excitations ((kσ,lσ)→(jσ′,Nσ)), paired doubles excitations-((i↑,j↓)→(N↓,N↑)), triples excitations involving paired doubles((l↑,k′↓,lσ)→(kσ,N↓,N ↑)). As a result, the Bloch equation leads to a polynomial equation system given by equations 6 to 9.

A^{(N),σ}=t^{1,σ}·h_{N}^{1,σ}t^{1σ}+t^{1σ}·h_{N}^{1,σ}−h_{NN}^{1,σ}t^{1,σ}−h_{N}^{1,σ} (6)

B^{(N),σv}=(t^{1,σ}⊗h_{N}^{1,v}⊗t^{1,v})₃₁₂+t^{1,σ}·(h_{N}^{2,σv}⊗t^{1,σ}+(h_{N}^{2,σv}⊗t^{1,σ})₂₁₄₃+δ_{v,-σ}h_{NN}²⊗t²+h^{2,σv}+(h^{2,σv})₂₁₄₃)−δ_{v,-σ}(δ_{σ↓}h_{N}^{1,σ}⊗(t²)₂₁)−h_{N}^{2,σv} (7)

C^{(N)}=t²·(h_{N}^{1,↑}⊗t^{1,↑}+h^{1,↑})−h^{1,↓}⊗t^{1,↑}+((t²)₂₁·(h_{N}^{1,↑}⊗t^{1,↓}+h^{1,↓}))₂₁−h_{N}^{1,↑}⊗t^{1,↓}+t²·(h_{N}^{2,↑↓}⊗t^{1,↑}+(h_{N}^{2,↑↓}⊗t^{1,↓})₂₁₄₃+ [symbol] +( [symbol] )₂₁₄₃+h_{NN}²⊗t²)−h_{NNNN}²t²−h_{NN}²−(h_{NN}^{1,↓}+h_{NN}^{1,↑})t² (8)

D^{(N),σ}=t²⊗(h_{N}^{1,σ}⊗t^{1,σ}+h^{1,σ})+(t²·h_{N}^{2,↑σ}⊗t^{1,↑})₃₁₂₄+((t²)₂₁·h_{N}^{2,↓σ}⊗t^{1,↓})₄₁₂₃+((t₂)²¹·(h_{N}^{2,σ↓})₂₁₃₄⊗t^{1,↑})₄₁₃₂+(t²·(h_{N}^{2,σ↑})₂₁₃₄⊗t^{1,↑})₃₁₄₂+δ_{σ↓}t²⊗h_{NN}²⊗t²−δ_{σ↑}(t²)₂₁⊗h_{NN}²⊗t²+(t²⊗h^{2,↑σ})₃₁₂₄+(t²⊗(h^{2,σ↑})₂₁₃₄)₃₁₂₄+((t²)₂₁⊗h^{2,↓σ})₄₁₂₃+((t²)₂₁⊗(h^{2,↓σ})₂₁₃₄)₄₁₃₂−(h_{N}^{2,↑σ}⊗t^{1,↓})₁₂₄₃−(h_{N}^{2,↑σ}⊗t^{1,↓})₁₂₃₄−h^{1,σ}⊗t² (9)

In the equations 6-9, t^{1σ} is a n₁=(N−1) length vector comprising singles excitation amplitudes. t_{N}^{2,σv} is a (N−1)² length vector comprised of doubles excitation amplitudes. The vectors h_{N}¹ and h_{N}² are of dimensions (N−1) and (N−1)³ and comprise one-electron integrals and two electron integrals coupling N^{th} MO to other MO's. h_{NN}² comprises all the two-electron integrals contributions that couples the paired excitation of the N^{th} MO with other spin orbitals. Here K⊗L denotes the tensor-product (⊗) of two vectors whose elements are (K⊗L)ᵢⱼ=KᵢLⱼ. In equations 6 to 9, (h^{2,σv})_{abcd} represents a permutation of indexes of the tensor for example, (h^{2,σv})₃₁₂₄)ᵢⱼₖₗ=(h^{2,σv})ₖᵢⱼₗ. And (·) represents tensor contraction. The downfolding equations 6-9 correspond to a rectangular system of multi-variable quadratic polynomials. There are m=2N⁴+4N³+N²+1 polynomial equations in n=N²+2(N−1) parameters. The residual vector G^{(N)} is determined from the polynomial equation system according to equation 10, wherein A=(A^{↑}, A^{↓}), B=(B^{↑↑}, B^{↑↓}, B^{↓↑}, B^{↓↓}), and D=(D^{↑}, D^{↓}).

G^{(N)}(t)=(A^{(N)},B^{(N)},C^{(N)},D^{(N)}) (10)

Once the residual vector is determined, at step 206D, the polynomial equation system is solved to update the one-electron and two-electron integrals by iteratively performing Levenberg-Marquadt Method (LMM) until norm of a product of a Jacobian matrix and the residual vector is less than a pre-defined tolerance value. In some other embodiments, any other second order gradient descent methods can be used instead of the LMM. The Jacobian matrix is obtained from the residual vector based on the plurality of similarity transformation parameters. For the kth iteration (step) of the LMM, the similarity transformation parameters (alternatively referred as parameter vector) is given by equation 11, the corresponding residual vector is given by equation 12, search direction of LMM is given by equation 13, the Jacobian matrix is obtained by equation 14 and a Hessian matrix is computed by equation 15.

tₖ=(tₖ^{1,↑},tₖ^{1,↓},tₖ²)^{T} (11)

Gₖ^{(N)}=(Aₖ^{(N)},Bₖ^{(N)},Cₖ^{(N)},Dₖ^{(N)})^{T} (12)

d^{(N),k}(tₖ)=( [symbol] )⁻¹Jₖ^{T}Gₖ (13)

Jₖ^{(N)}=∇ₜ⊗G^{(N)} (14)

[symbol]

=(Jₖ^{(N)})^{T}Jₖ^{(N)}+μₖ, wherein μₖ is a positive parameter (15)

LMM is performed until norm of a product of a Jacobian matrix and the residual vector is less than a pre-defined tolerance value. In other words the convergence criterion is ∥JₖGₖ∥<ϵ, where ϵ is tolerance value or threshold value. The upper bound of the total number of LMM iterations is given by equation 16.

total number of

$$LMM iterations < \frac{{U}_{J}^{2} ϕ ( {t}_{0} )}{{ϵ}^{2}} \qquad ( 16 )$$

where U_{J}² is upper bound of 2-norm of the Jacobian matrix and

$$ϕ ( {t}_{0} ) = \frac{1}{2} {‖ {G}_{0}^{( N )} ‖}^{2} .$$

At each iteration of LMM, firstly a LMM update rule is formulated to update the plurality of similarity transformation parameters based on the residual vector and inverse of the Hessian matrix as given by equation 17. Computing the inverse of the Hessian matrix on the classical hardware processors is computationally intensive. The classical computational complexity of inverting the matrix scales as [symbol] =O(n³)=O(N⁶). Thus, calculating ( [symbol] )⁻¹ is the computational bottleneck of the LMM method.

tₖ₊₁=tₖ+( [symbol] )⁻¹Jₖ^{T}Gₖ (17)

Therefore, at next step the LMM update rule is transformed into a quantum linear system by encoding the Hessian matrix on a quantum circuit. Since the row index of the Hessian matrix ranges from 1 to n=O(N²), a quantum computer system of

$$\frac{D}{2} = 2$$

log N qubits is considered. For this system,

$$\frac{D}{2} + 2$$

ancilla qubits are added. Quantum registers α₁ and α₂ have one qubit each and quantum register α₃ involves D qubits. With these qubits a unitary oracle is constructed according to equation 18.

$${\hat{O}}_{ℍ} = {\sum }_{r , c ∈ F ( r )} \vert r {〉}_{s} \vert c {〉}_{{a}_{2}} 〈 r {\vert}_{s} 〈 c {\vert}_{{a}_{2}} ⊗ {e}^{i {θ}_{rc} {Y}_{{a}_{1}}} ⊗ \vert 0 {〉}_{{a}_{3}} 〈 0 {\vert}_{{a}_{3}} \qquad ( 18 )$$

Here, r denotes row index of the Hessian matrix ranging from 1 to n=N²+2N−2, c is column index on the r^{th} row whose value belongs to F(r) and F(r) is a set comprising d non-zero entries along the r^{th} row. The rotation generator and rotation angle on α₁ space are given by equation 19 and 20, respectively. Initial state on the qubit system is given as in equation 21.

$${θ}_{rc} = arccos \sqrt{\frac{{ℍ}_{rc}}{‖ ℍ ‖}} \qquad ( 19 )$$

$${Y}_{{a}_{1}} = i ( \vert 0 {〉}_{{a}_{1}} 〈 1 {\vert}_{{a}_{1}} - \vert 1 {〉}_{{a}_{1}} 〈 0 {\vert}_{{a}_{1}} ) \qquad ( 20 )$$

$$\vert ψ ( r ) 〉 = \vert r {〉}_{s} \vert 0 {〉}_{{a}_{1}} \frac{1}{\sqrt{D}} {\sum }_{c = 0}^{d - 1} \vert c {〉}_{{a}_{2}} \vert 0 {〉}_{{a}_{3}} \qquad ( 21 )$$

Next, a unitary oracle O_{F}|i, j [symbol] =|i, f(j) [symbol] is introduced where f(j) is another column index and i is a row index. The exact mathematical operation of O_{F} on register s and α₂ is a permutation as given by equation 22.

$${O}_{F} \vert ψ ( r ) 〉 = \vert r {〉}_{s} \vert 0 {〉}_{{a}_{1}} \frac{1}{\sqrt{D}} {\sum }_{c ∈ f ( r )}^{d - 1} \vert c {〉}_{{a}_{2}} \vert 0 {〉}_{{a}_{3}} \qquad ( 22 )$$

Combining [symbol] and O_{F}|ϕ(r) [symbol] is constructed as in equation 23.

$$\vert ϕ ( r ) 〉 = {\hat{O}}_{F} \vert ψ ( r ) 〉 = \frac{1}{\sqrt{D}} {\sum }_{c ∈ f ( r )} \vert r {〉}_{s} ( \sqrt{\frac{{ℍ}_{rc}}{‖ ℍ ‖}} \vert 0 {〉}_{{a}_{1}} + \sqrt{1 - \frac{{ℍ}_{rc}}{‖ ℍ ‖}} \vert 1 {〉}_{{a}_{1}} ) \vert c {〉}_{{a}_{2}} \vert 0 {〉}_{{a}_{3}} \qquad ( 23 )$$

Then, another state is created using swap operation S that interchanges the registers α₂, s and α₁, α₃. The swap operation is performed according to equation 24.

$${SO}_{ℍ} {O}_{F} \vert ϕ ( r ) 〉 = \frac{1}{\sqrt{D}} {\sum }_{p ∈ f ( k )} \vert p {〉}_{s} \vert 0 {〉}_{{a}_{1}} \vert k {〉}_{{a}_{2}} ( \sqrt{\frac{{ℍ}_{pk}}{‖ ℍ ‖}} \vert 0 {〉}_{{a}_{3}} + \sqrt{1 - \frac{{ℍ}_{pk}}{‖ ℍ ‖}} \vert 1 {〉}_{{a}_{3}} ) \qquad ( 24 )$$

Thus, the unitary circuit is [symbol] =O_{F}^{†}O_{H}^{†}SO_{H}O_{F}. The elements of the Hessian matrix can now be accessed from the overlaps as in equation 25.

$$〈 ψ ( c ) \vert {O}_{F}^{†} {O}_{H}^{†} {SO}_{H} {O}_{F} \vert ψ ( r ) 〉 = \frac{{H}_{rc}}{∥ H ∥} \qquad ( 25 )$$

Once the Hessian matrix is encoded on the quantum circuit, inverse of the Hessian matrix is computed using qubitized quantum walks. In an embodiment, Child's Quantum walk approach is used for matrix inversion using Chebyshev polynomials. Similar quantum algorithms maybe used in other embodiments. Once the inverse of the Hessian matrix is obtained, the similarity transformation parameters are updated according to the LMM update rule given by equation 17. This is repeated until the convergence criterion is satisfied. Then, one-electron and two-electron integrals are updated using the updated similarity transformation parameters according to equations 26 and 27 and number of molecular orbitals is reduced by 1 (i.e., N−>N−1).

hᵢⱼ^{1,σ,(N-1)}=hᵢⱼ^{1,σ,(N)}+h_{iN}^{1,σ,(N)}tⱼ^{1,σ,(N)} (26)

hᵢⱼₖₗ^{2,σv,(N-1)}=hᵢⱼₖₗ^{2,σv,(N)}+h_{ijkN}^{2,σv,(N)}tⱼ^{1,σ,(N)}+δ_{v,-σ}h_{ijNN}^{2,(N)}tₖₗ^{2,(N)} (27)

It can be observed that the indexes in the one and two-electron tensors runs over MO indices 1 to N−1 i.e. leaving out the N^{th} MO. The N^{th} orbital gets decoupled with only an overall diagonal contribution. This remains true even if N∈C where P_{(N)}=n\hat{ }^{↑}n\hat{ }^{↓}, and for N∈A: P_{(N)}=n\hat{ }^{↑}n\hat{ }^{↓} or (1−n\hat{ }^{↑})(1−n\hat{ }^{↓}). However, in that case, the energetic contribution from the diagonal term may change. Another observation is that no new many-body excitation clusters are created. This results from the choice of n where paired doubles at the N^{th} MO get excited. The choice of n automatically terminates the hierarchy of the three particle or higher-order clusters. Such a description allows the self-similar representation of the Hamiltonian to prevail. In the next iteration, Hamiltonian for a system of N−2 MOs are derived from the N−1 MOs. Thus, iteratively performing the plurality of steps results in downfolding of active space of electronic Hamiltonian since at each iteration a qubit Hamiltonian is constructed for one molecular orbital less than the one constructed in a previous iteration.

### Use Case Examples

Example 1: For drug screening, an accurate potential energy surface of a drug molecule is obtained from the method 200 disclosed herein. Then, gradients are studied from the PES and the forces associated with the displacement of the ligand molecules in protein environment are calculated. This will enable more accurate assessment of ligand-protein binding configurations. Further dynamical response functions can be calculated which helps better determination of the binding.

Example 2: For selecting cathode materials for rechargeable batteries, accurate optimized geometry of the cathode molecules in electrolyte environment, and associated ground state energy are calculated from the method 200. This will then be used to compute more accurate energy enthalpy differences for the redox reactions. In turn the energy enthalpy differences are used to calculate high open cell voltages(OCV) (equilibrium voltage). A higher OCV leads to a higher cut-off for the recharging voltage. Cathode materials with different co-doped transition metal oxides (like Co, Ni, Mn) are screened using high OCV as the deciding factor.

Example 3: In order to attain carbon neutrality in the near future, novel capture technologies have to be discovered. Carbon dioxide adsorption on amine polymers is one such technology. To assess the amount of carbon dioxide that can be adsorbed the BET surface area is computed from classical Molecular dynamics, but it requires calculating the potential energy surface (PES) from electronic calculations. Calculating an accurate PES with post-DFT corrections is computationally expensive which can be overcome by the method 200 disclosed herein.

### Experimental Results

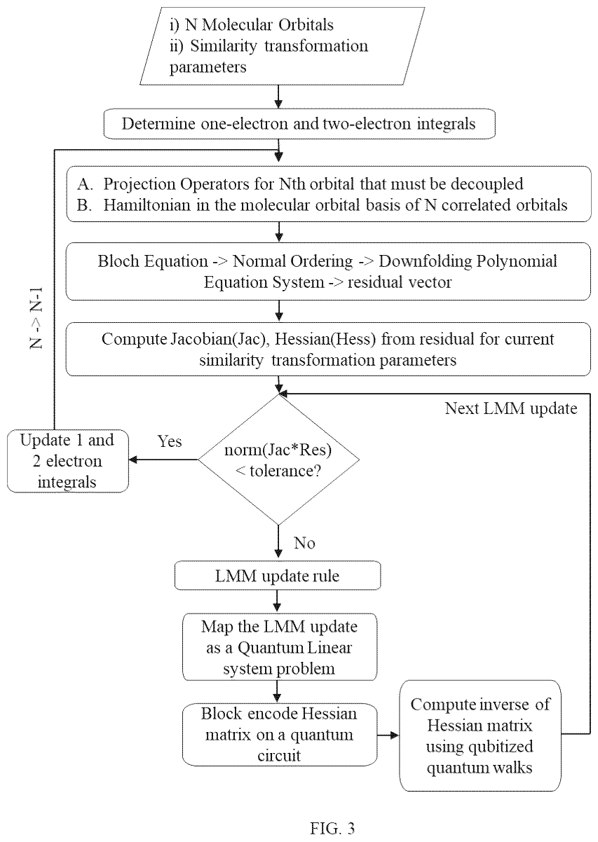

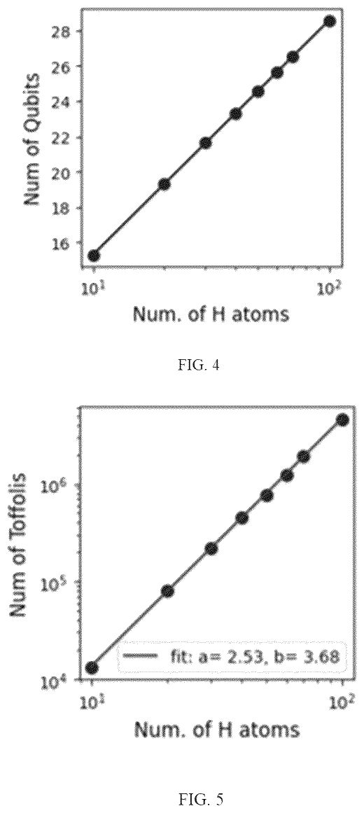

The method 200 was experimented on a Hydrogen chain. FIG. 4 illustrates number of qubits required for downfolding of Hydrogen atoms using method 200, in accordance with some embodiments of the present disclosure. FIG. 5 illustrates number of Toffoli's required for downfolding of Hydrogen atoms using method 200, in accordance with some embodiments of the present disclosure. Total runtime of method 200 was O(136N³/ϵ²). Number of qubits used was 4 Log N+2 and number of Toffoli's used were O(10N^{2.53} log(1/ϵ)). From the results, sublinear scaling of the number of qubits with system size (logarithm scaling) can be observed that is much better compared to number of qubits scaling from the qubitized phase estimation. Also, exponential improvement in the precision is obtained with similar order of gates as required in Qubitized phase estimation (Ref. PRX Quantum 2, 030305 (2021)—Even More Efficient Quantum Computations of Chemistry Through Tensor Hypercontraction (aps.org)).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The present disclosure solves the unresolved problem of Hamiltonian downfolding using hybrid quantum-classical computer. In the state-of-the-art approaches both the coupled cluster, double unitary coupled cluster transformations are formulated in the exponential representation of the generator. If the double unitary coupled cluster needs to be directly implemented in a quantum circuit then long Trotter circuit representation of such unitary transformations has to be done which lead to dense quantum circuits. In order to overcome this issue, the present disclosure constructs an alternative generator that leads to automatic termination of the associated similarity transformation (exponentiation of the generator) to linear order. This simplified transformation can be represented with a fewer gates albeit with extra ancilla qubits (given that it has finite number of terms) on a quantum circuit. This will allow the approach of Hamiltonian downfolding to be implemented in near term where shallow depth circuits can be implemented and enable efficient construction of simpler effective Hamiltonians.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A quantum simulation method performed by a system comprising one or more classical hardware processors and a plurality of unentangled Quantum Processor Units (QPUs), wherein the one or more classical hardware processors are communicably coupled to the plurality of unentangled QPUs by respective interfaces, wherein the quantum simulation method comprising:
receiving, by the one or more classical hardware processors, a plurality of molecular orbitals associated with a plurality of molecules and a plurality of similarity transformation parameters;
determining, by the one or more classical hardware processors, one-electron and two-electron integrals based on each of the plurality of molecular orbitals; and
iteratively performing, by the one or more classical hardware processors and the plurality of unentangled QPUs, a plurality of steps until number of the plurality of molecular orbitals is zero, wherein number of the plurality of molecular orbitals is reduced by one at each iteration, and wherein the plurality of steps comprising:
determining, by the one or more classical hardware processors, a plurality of projection operators for last molecular orbital that has to be decoupled among the plurality of molecular orbitals;
constructing, by the one or more classical hardware processors, a qubit Hamiltonian based on the one-electron and two-electron integrals;
determining, by the one or more classical hardware processors, a residual vector by transforming the qubit Hamiltonian to a polynomial equation system using the plurality of projection operators; and
solving, by the one or more classical hardware processors and the plurality of unentangled QPUs, the polynomial equation system to update the one-electron and two-electron integrals by iteratively performing Levenberg-Marquadt Method (LMM) until norm of a product of a Jacobian matrix and the residual vector is less than a pre-defined tolerance value, wherein the Jacobian matrix is obtained from the residual vector based on the plurality of similarity transformation parameters.

2. The method of claim 1, wherein iteratively performing Levenberg-Marquadt Method (LMM) comprises:
formulating, by the one or more classical hardware processors, a LMM update rule to update the plurality of similarity transformation parameters based on the residual vector and inverse of a Hessian matrix, wherein the Hessian matrix is obtained from the residual vector;
transforming, by the one or more classical hardware processors, the LMM update rule into a quantum linear system by encoding the Hessian matrix on a quantum circuit;
computing, by the plurality of unentangled QPUs, inverse of the Hessian matrix using qubitized quantum walks; and
updating, by the one or more classical hardware processors, the plurality of similarity transformation parameters based on the LMM update rule.

3. The method of claim 1, wherein iteratively performing the plurality of steps results in downfolding of active space of electronic Hamiltonian since at each iteration a qubit Hamiltonian is constructed for one molecular orbital less than the one constructed in a previous iteration.

4. A system comprising:
one or more classical hardware processors and a plurality of unentangled Quantum Processor Units (QPUs), wherein the one or more classical hardware processors are communicably coupled to the plurality of unentangled QPUs by respective interfaces, wherein the one or more classical hardware processors comprises at least one memory storing programmed instructions; one or more Input/Output (I/O) interfaces; and one or more hardware processors operatively coupled to the at least one memory, wherein the one or more hardware processors and the plurality of unentangled QPUs are configured by the programmed instructions to:
receive a plurality of molecular orbitals associated with a plurality of molecules and a plurality of similarity transformation parameters;
determine one-electron and two-electron integrals based on each of the plurality of molecular orbitals; and
iteratively perform a plurality of steps until number of the plurality of molecular orbitals is zero, wherein number of the plurality of molecular orbitals is reduced by one at each iteration, and wherein the plurality of steps comprising:
determining a plurality of projection operators for last molecular orbital that has to be decoupled among the plurality of molecular orbitals;
constructing a qubit Hamiltonian based on the one-electron and two-electron integrals;
determining a residual vector by transforming the qubit Hamiltonian to a polynomial equation system using the plurality of projection operators;
solving the polynomial equation system to update the one-electron and two-electron integrals by iteratively performing Levenberg-Marquadt Method (LMM) until 2−norm of a product of a Jacobian matrix and a Hessian matrix is less than a pre-defined tolerance value, wherein the Jacobian matrix and the Hessian matrix are obtained from the residual vector based on the plurality of similarity transformation parameters.

5. The system of claim 4, wherein iteratively performing Levenberg-Marquadt Method (LMM) comprises:
formulating, by the one or more classical hardware processors, a LMM update rule to update the plurality of similarity transformation parameters based on the residual vector and inverse of the Hessian matrix;
transforming, by the one or more classical hardware processors, the LMM update rule into a quantum linear system by encoding the Hessian matrix on a quantum circuit;
computing, by the plurality of unentangled QPUs, inverse of the Hessian matrix using qubitized quantum walks; and
updating, by the one or more classical hardware processors, the plurality of similarity transformation parameters based on the LMM update rule.

6. The system of claim 4, wherein iteratively performing the plurality of steps results in downfolding of active space of electronic Hamiltonian since at each iteration a qubit Hamiltonian is constructed for one molecular orbital less than the one constructed in a previous iteration.

7. One or more non-transitory machine-readable information storage mediums comprising one or more instructions which when executed cause:
receiving, by the one or more classical hardware processors, a plurality of molecular orbitals associated with a plurality of molecules and a plurality of similarity transformation parameters;
determining, by the one or more classical hardware processors, one-electron and two-electron integrals based on each of the plurality of molecular orbitals; and
iteratively performing, by the one or more classical hardware processors and the plurality of unentangled QPUs, a plurality of steps until number of the plurality of molecular orbitals is zero, wherein number of the plurality of molecular orbitals is reduced by one at each iteration, and wherein the plurality of steps comprising:
determining, by the one or more classical hardware processors, a plurality of projection operators for last molecular orbital that has to be decoupled among the plurality of molecular orbitals;
constructing, by the one or more classical hardware processors, a qubit Hamiltonian based on the one-electron and two-electron integrals;
determining, by the one or more classical hardware processors, a residual vector by transforming the qubit Hamiltonian to a polynomial equation system using the plurality of projection operators; and
solving, by the one or more classical hardware processors and the plurality of unentangled QPUs, the polynomial equation system to update the one-electron and two-electron integrals by iteratively performing Levenberg-Marquadt Method (LMM) until norm of a product of a Jacobian matrix and the residual vector is less than a pre-defined tolerance value, wherein the Jacobian matrix is obtained from the residual vector based on the plurality of similarity transformation parameters.

8. The one or more non-transitory machine-readable information storage mediums of claim 7, wherein iteratively performing Levenberg-Marquadt Method (LMM) comprises:
formulating, by the one or more classical hardware processors, a LMM update rule to update the plurality of similarity transformation parameters based on the residual vector and inverse of a Hessian matrix, wherein the Hessian matrix is obtained from the residual vector;
transforming, by the one or more classical hardware processors, the LMM update rule into a quantum linear system by encoding the Hessian matrix on a quantum circuit;
computing, by the plurality of unentangled QPUs, inverse of the Hessian matrix using qubitized quantum walks; and
updating, by the one or more classical hardware processors, the plurality of similarity transformation parameters based on the LMM update rule.

9. The one or more non-transitory machine-readable information storage mediums of claim 7, wherein iteratively performing the plurality of steps results in downfolding of active space of electronic Hamiltonian since at each iteration a qubit Hamiltonian is constructed for one molecular orbital less than the one constructed in a previous iteration.
